(19) United States
(12) Patent Application Publication
(10) Pub. No.: US 2003/0216134 A1
(43) Pub. Date: Nov. 20, 2003

(54) Phone having emergency call function with securely receiving incoming call

(76) Inventor: Katsuhiko Mutoh, Obu-city (JP)

Correspondence Address: HARNESS, DICKEY & PIERCE, P.L.C., P.O. BOX 828, BLOOMFIELD HILLS, MI, 48303, US

(21) Appl. No.: 10/435,308

(22) Filed: May 9, 2003

(30) Foreign Application Priority Data
May 15, 2002 (JP) 2002-140617

(51) Int. Cl. H04M 1/00; H04B 1/38

(52) U.S. Cl. 455/404.1; 455/567

(57) ABSTRACT

When a crew of a vehicle runs into a traffic accident or suffers sudden illness, a control circuit of a phone device in the vehicle releases prohibition of outputting an incoming ring in memory to set a ring volume to the maximum. Even if the incoming ring is previously set being prohibited from outputting while the driving, the incoming ring is thereby outputted at the maximum volume from a ringer when an incoming call is received after the emergency occurs.

### CROSS REFERENCE TO RELATED APPLICATIONS

This application is based on and incorporates herein by reference Japanese Patent Application No. 2002-140617 filed on May 15, 2002.

### FIELD OF THE INVENTION

The present invention relates to a phone having an emergency call function that notifies an emergency call addressee of an emergency state. In particular, the phone is capable of securely receiving an incoming call from the emergency call addressee.

### BACKGROUND OF THE INVENTION

A vehicle phone device having an emergency call function is proposed as described in Japanese patent of JP-B2-P3142262. When an emergency state occurs, the emergency call function notifies the emergency center, which is previously registered, of the emergency state by automatically calling in the emergency call center.

Thereby a crew of a vehicle can rapidly notify the emergency call center when a traffic accident occurs or sudden illness is suffered. According to the notice from the vehicle, the emergency call center asks a fire station for sending an ambulance together with notifying a family of the crew that the emergency state is occurs.

There is a case where the vehicle phone is previously set being prohibited from outputting an incoming ring for avoiding receiving an incoming call during the driving. Thereby, after communication with the emergency center is shut off, the vehicle phone continues to be prohibited from outputting the incoming ring. Even if the family wishes to call to the vehicle phone to inquire after the crew, the crew cannot recognize the incoming call due to no ring of the incoming call.

After the traffic accident occurs, the crew may not manipulate release of prohibiting the incoming ring due to being physically disabled after the accident even if the crew wishes to do so. Otherwise, the crew may forget to release prohibiting the incoming ring due to being confused after the accident.

### SUMMARY OF THE INVENTION

It is an object of the present invention to provide a phone having an emergency call function with securely receiving an incoming call when an emergency state occurs.

To achieve the above object, a phone having an emergency call function is provided with the following. A ring volume of an incoming ring is set to a certain volume level for notifying a user of an incoming call. Occurrence of an emergency state is determined. An emergency call is executed to an emergency call addressee that is previously appointed when occurring of the emergency state is determined. The ring volume is changed to set from the certain volume level to a given volume level that is louder than the certain volume level when occurring of the emergency state is determined.

It is preferable that a ring volume manipulation signal that indicates the given volume level to be set is received from the emergency call addressee when occurring of the emergency state is determined.

It is furthermore preferable that the output of the incoming ring is prohibited before occurrence of the emergency state is determined and then release of prohibiting of the output of the incoming ring is permitted when occurring of the emergency state is determined while the output of the incoming ring is prohibited at least one of two conditions,

wherein a first condition is that a predetermined period elapses from the occurring of the emergency state is determined and a second condition is that a ring permission signal that indicates permitting the outputting of the incoming ring is received from the emergency call addressee.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view of an emergency call system according to a first embodiment of the present invention;

FIG. 2 is a structural block diagram of a vehicle phone device of the emergency call system according to the first embodiment;

FIG. 3 is a flowchart diagram explaining first processing of a control circuit of the vehicle phone device according to the first embodiment;

FIG. 4 is a flowchart diagram explaining second processing of the control circuit of the vehicle phone device according to the first embodiment;

FIG. 5 is a schematic view explaining operation of the emergency call system according to the first embodiment;

FIG. 6 is a flowchart diagram explaining processing of a control circuit of a vehicle phone device of an emergency call system according to a second embodiment; and

FIG. 7 is a flowchart diagram explaining processing of a phone of a service center of the emergency call system according to the second embodiment.

### DETAILED DESCRIPTION OF THE PREFERRED EMBODIMENTS

(First Embodiment)

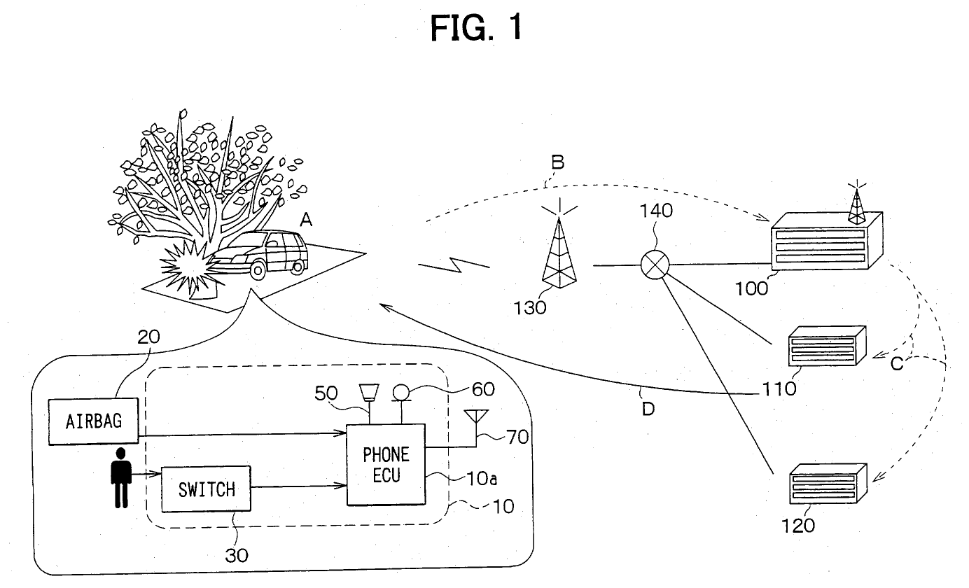

Referring to FIG. 1, an emergency call system relating to a vehicle phone device having an emergency call function as an embodiment of the present invention is explained below.

When a crew of a vehicle runs into a traffic accident or suffers sudden illness (A in FIG. 1), a vehicle phone device 10 mounted in the vehicle calls in a service center 100 of the emergency call system. The vehicle phone device 10 thereby notifies (B in FIG. 1) an operator of the service center 100 of an emergency state through a base station 130 of a cell phone network and a public service network 140. The service center 100 provides with an intermediate service based on contracts with the crew and a provider of the cell phone network.

The operator of the service center 100 asks a police or a fire station (C in FIG. 1) for emergency assistance (D in FIG. 1) using a phone via the public service network 140, and notifies (C in FIG. 1) home of the crew of the emergency state of the crew via the public service network 140.

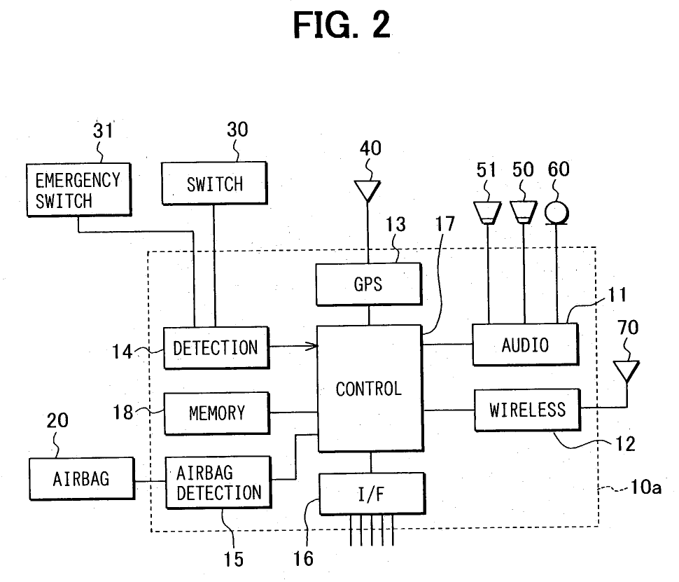

Referring to FIG. 2, structure of the vehicle phone device 10 will be explained below.

The vehicle phone device 10 includes a phone electronic control unit (ECU) 10a, a manipulation switch 30, an emergency call switch 31, a GPS antenna 40, a speaker 50, a microphone 60, a ringer 51, and an antenna 70. The phone ECU 10a includes an audio processing circuit 11, a wireless circuit 12, a GPS receiving circuit 13, a manipulation detection circuit 14, an airbag spreading detection circuit 15, a vehicle control interface (IF) circuit 16, a control circuit 17, and a memory 18.

The wireless circuit 12 receives a downlink communication signal from the base station 130 of the cell phone network through the antenna 70, while it generates to transmit an uplink communication signal through the antenna 70 by modulating a transmission signal.

The audio processing circuit 11 converts a reception signal received in the wireless circuit 12 from digital to analog to output a receiving voice via the speaker 50. It also converts a transmission voice via the microphone 60 from analog to digital to generate a transmission signal. It furthermore generates an incoming ring for notifying the crew of an incoming call via the ringer 51.

The GPS receiving circuit 13 obtains a current position of the vehicle based on satellite signals received from GPS satellites via the GPS antenna 40. The manipulation detection circuit 14 detects a manipulation signal outputted from the manipulation switch 30 or the emergency call switch 31. The manipulation switch 30 includes various keys (not shown) as follows: a call start key for calling in or accepting the incoming call; a stop key for stopping a call; a ringer prohibition key for prohibiting the incoming ring; and a release key for releasing the prohibition of the incoming ring. The manipulation switch 30 also includes a ring volume key for switching a ring volume to low, intermediate, or high level. The emergency call switch 31 is manipulated by the crew when the emergency state such as sudden illness of the crew occurs.

The airbag spreading detection circuit 15 detects a spreading signal indicating spreading of an airbag by an airbag device 20. The vehicle control IF circuit 16 transmits a control signal to in-vehicle devices (not shown) such as a door-lock control device, a light control device, and a horn control device.

The control circuit 17 is provided with a microcomputer digital signal processor to execute processing for notifying the service center 100 at the emergency state through communication between the wireless circuit 12 and the base station 130. The control circuit 17 also executes processing at the emergency state for allowing to output the incoming ring and setting the ring volume of the incoming ring to the maximum as described later.

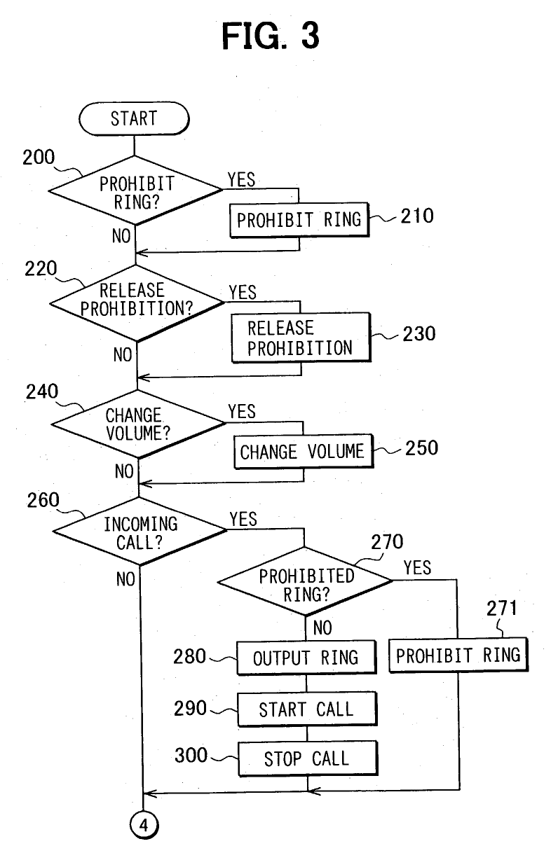

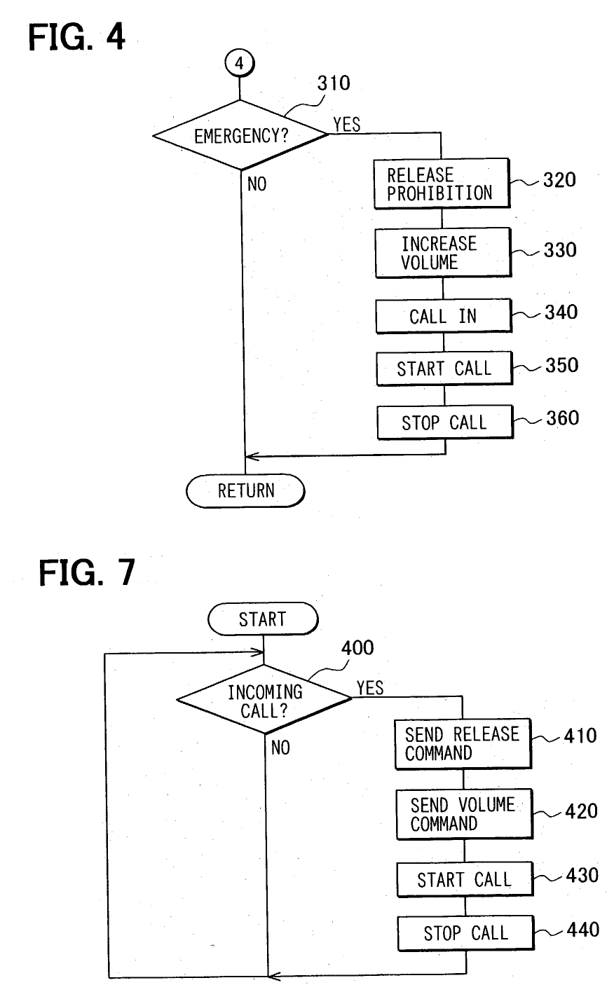

Referring to FIGS. 3 and 4, processing of the control circuit 17 of the vehicle phone device 10 according to the first embodiment will be explained. Here the processing is periodically executed during a waiting state.

At Step 200, whether the ringer prohibition key of the manipulation switch 30 is manipulated by the crew is determined. When the ringer prohibition key is manipulated, outputting of the incoming ring is prohibited. The manipulation of the ringer prohibition key is detected based on an output signal from the manipulation detection switch 14. When the ringer prohibition key is determined to be manipulated, prohibition of outputting the incoming ring is thereby set in the memory 18 at Step 210.

At Step 220, whether the release key of the manipulation switch 30 is manipulated by the crew is determined. When the release key is manipulated, the prohibition of outputting the incoming ring is released. The manipulation of the release key is detected based on an output signal from the manipulation detection switch 14. When the release key is determined to be manipulated, prohibition of outputting the incoming ring is thereby released in the memory 18 at Step 230.

At Step 240, whether the ring volume key of the manipulation switch 30 is manipulated by the crew is determined. When the ring volume key is manipulated, the ring volume to be outputted is switched. The manipulation of the release key is detected based on an output signal from the manipulation detection switch 14. When the ring volume key is determined to be manipulated, the ring volume of outputting the incoming ring is thereby switched to set in the memory 18 a setting level manipulated by the crew at Step 250.

At Step 260, whether an incoming signal from the base station 130 is received through the wireless circuit 12 is determined. When the incoming signal is determined to be received, whether the prohibition of outputting the incoming ring is set in the memory 18 is determined at Step 270. When the prohibition of outputting the incoming ring is determined to be not set in the memory 18, the setting level of the ring volume that is set by the crew is read out from the memory 18. The incoming ring is outputted at the setting level from the ringer 51 at Step 280.

As the crew manipulates for accepting the incoming call through the call start key of the manipulation switch 30, an off-hook signal is transmitted from the wireless circuit 12 to the base station 130 to connect through a phone line with an opponent party. As a downlink communication signal from the opponent party is received through the base station 130 by the wireless circuit 12, a receiving voice is outputted from the speaker 60 by the audio processing circuit 11 based on the downlink communication signal. As a transmitting voice is inputted through the microphone 60, an uplink communication signal is transmitted by the wireless circuit 12 through the base station 130 based on the transmitting voice at Step 290.

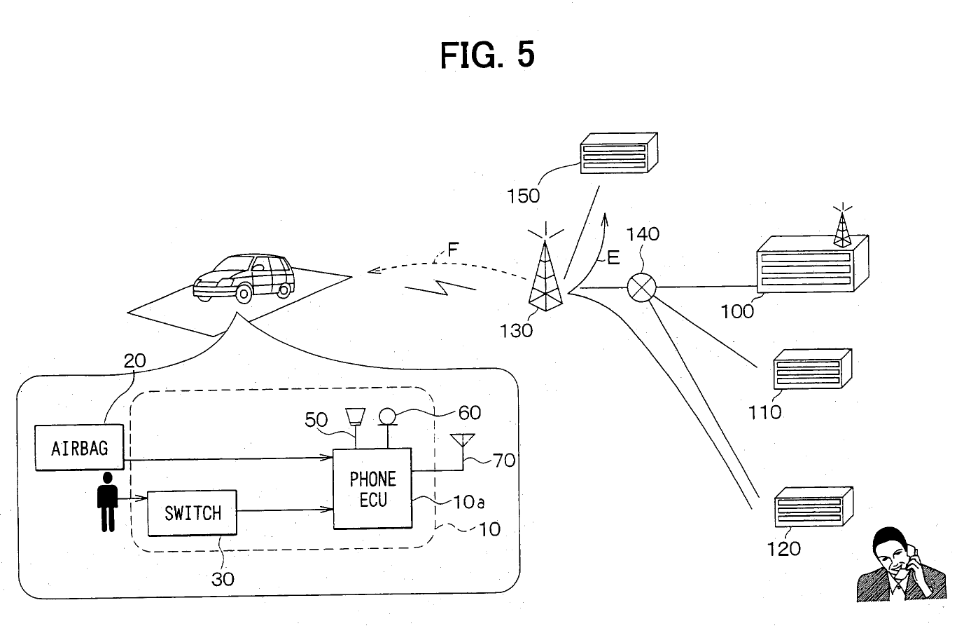

The crew can thereby have a hands-free call with the opponent party using the speaker 50 and the microphone 60. As the crew manipulates for stopping the call through the stop key of the manipulation switch 30, a call stop signal is transmitted from the wireless circuit 12 to the base station 130 at Step 300. The phone line with the opponent part is thereby terminated. At Step 270, when the prohibition of outputting the incoming ring is determined to be set in the memory 18, the incoming ring is not outputted from the ringer 51. Here, a voice mail center 140 (shown in FIG. 5) in the cell phone network automatically transmits to the opponent party a message of an effect that the crew is not ready for accepting the incoming call.

As explained above, the vehicle phone device 10 is utilized based on the manipulation by the crew in a normal state. The incoming ring is outputted at the manipulated setting level of the ring volume so that the crew can have a hands-free call during the driving. Outputting of the incoming ring from the ringer 51 is prohibited so that the crew can be concentrated on the driving.

By contrast, a case where an emergency state occurs is explained referring to FIG. 4. At Step 310, whether the emergency state occurs determined. The emergency state is determined based on spreading of an airbag or manipulation of the emergency call switch 31. The spreading of the airbag is determined based on an output signal from the airbag spreading detection circuit 15 when the airbag is spread by the airbag device 20 due to a collision accident. The emergency call switch 31 is manipulated, for instance, when the crew that suffers the sudden illness wants an emergency call.

Here, when outputting of the incoming ring is prohibited in the memory 18 before the emergency state is determined, release of the prohibition of outputting the incoming ring is set in the memory 18 at Step 330. When the outputting of the incoming ring is set to be available, the setting is retained with newly setting the ring volume to the maximum at Step 330.

For instance, when the ring volume of outputting the incoming ring is set to “low” or “intermediate,” the ring volume is newly set to “high” in the memory 18 at Step 330. When the ring volume of outputting the incoming ring is set to “high,” the ring volume continues to be set to “high” in the memory 18 at Step 330.

As the ring volume is set to “high,” processing for calling in the service center 100 based on a registered phone number stored in the memory 18 is executed at Step 340. A calling signal is thereby transmitted from the wireless circuit 12 to the base station 130 to connect through the phone line with the service center 100.

As a transmitting voice is inputted through the microphone 60, an uplink communication signal is transmitted by the wireless circuit 12 to the service center 100 through the base station 130 and the public service network 140 based on the transmitting voice. As a downlink communication signal from the service center 100 is received through the base station 130 and the public service network 140 by the wireless circuit 12, a receiving voice is outputted from the speaker 60 by the audio processing circuit 11 based on the downlink communication signal. These are executed at processing at Step 350.

The crew can thereby have a hands-free call for the emergency call with the operator of the service center 100 using the speaker 50 and the microphone 60. In addition, a current position of the vehicle obtained from the GPS receiving circuit 13 can be properly transmitted as an accident spot to the service center 100.

When the crew thereafter manipulates for stopping the call through the stop key of the manipulation switch 30, a call stop signal is transmitted from the wireless circuit 12 to the base station 130 and the phone line with the service center 100 is shut off.

The crew can thereby have the hands-free call for the emergency call with the operator of the service center 100. The operator of the service center 100 asks the police or the fire station for the emergency assistance, and notifies home of the crew of the emergency state of the crew.

When the family of the crew calls from a phone at home 120 to the vehicle phone device 10 to inquire after the crew, an incoming signal (F in FIG. 5) is transmitted to the vehicle phone device 10 through the public service network 140 and the base station 130 to start the following processing.

The incoming signal is determined to be received at Step 260, and the prohibition of outputting the incoming ring is determined to be not set in the memory 18 at Step 270. The setting level “high” of the ring volume that is set at Step 330 is read out from the memory 18. The incoming ring is outputted at the setting level “high” from the ringer 51 at Step 280.

As explained above, when the crew of the vehicle runs into the traffic accident or suffers the sudden illness, the prohibition of outputting the incoming ring is released and the ring volume is set to “high.” Thereby even if the prohibition of outputting the incoming ring is set in the memory 18 during the driving before the emergency state occurs, the crew can recognize the incoming ring. Namely the incoming ring can be outputted from the ringer 51 at the maximum level of “high.”

(Second Embodiment)

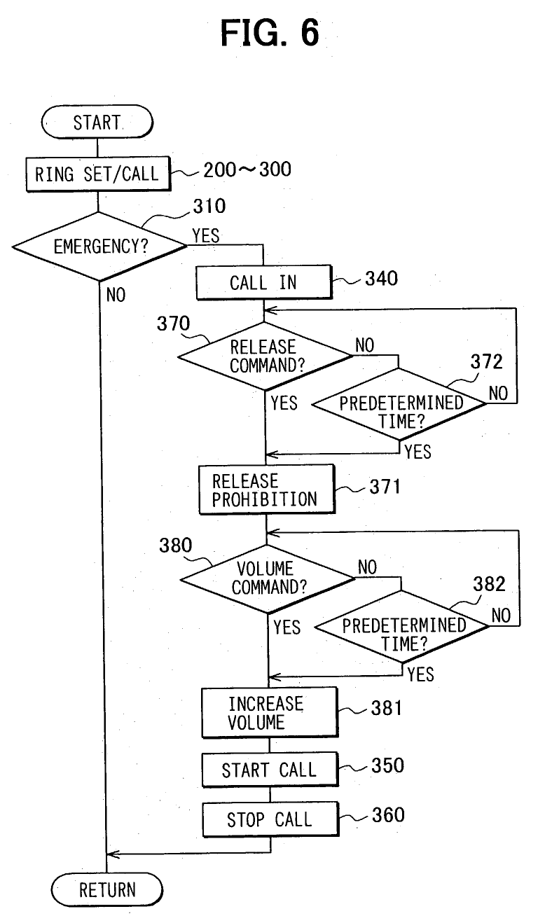

In a second embodiment, the release of the prohibition of outputting the incoming ring, and the setting of the ring volume at the maximum level are executed remotely from the service center 100 through the phone line. Processing in the second embodiment will be explained referring to FIGS. 6 and 7.

Processing in FIG. 6 is executed by the control circuit 17 while processing in FIG. 7 is executed by the phone of the service center 100.

Firstly, the control circuit 17 executes each processing at Steps 200 to 300 in FIG. 3. At Step 310 in FIG. 6, whether the emergency state occurs determined. The emergency state is determined based on spreading of an airbag or manipulation of the emergency call switch 31. The spreading of the airbag is determined based on an output signal from the airbag spreading detection circuit 15 when the airbag is spread by the airbag device 20 due to a collision accident. The emergency call switch 31 is manipulated, for instance, when the crew that suffers the sudden illness wants an emergency call.

When the emergency state is determined, processing for calling in the service center 100 based on a registered phone number stored in the memory 18 is executed at Step 340. A calling signal is thereby transmitted to the public service network 140 from the wireless circuit 12 to the base station 130. When the calling signal is received at the phone of the service center 100 as an incoming signal, the phone of the service center 100 determines that there is an incoming call at Step 400 in FIG. 7. Simultaneously an off-hook signal is transmitted from the phone of the service center 100 to the public service network 140 to connect through the phone line with the vehicle phone device 10.

At Step 410, the phone of the service center 100 transmits a ring-off release command for remotely releasing the prohibition of outputting the incoming ring to the vehicle phone device 10 through the public service network 140 and the base station 130. In addition, at Step 420, the phone of the service center 100 transmits a ring-volume increase command for remotely increasing the ring volume to the maximum to the vehicle phone device 10 through the public service network 140 and the base station 130.

Here, when the control circuit 17 of the vehicle phone device 10 receives the ring-off release command through the wireless circuit 12 for a predetermined period (determined at Step 372) after calling to the service center 100 at Step 340, the ring-off release command is determined to be received at Step 370. The control circuit 17 then releases the prohibition of outputting the incoming ring, or sets permission of outputting the incoming ring in the memory 18 at Step 371. The control circuit 17 can thereby permit the outputting of the incoming ring to the memory 18 by a remote operation of the service center 100.

Furthermore, when the control circuit 17 of the vehicle phone device 10 receives the ring-volume increase command through the wireless circuit 12 for a predetermined period (determined at Step 382), the ring-volume increase command is determined to be received at Step 380. The control circuit 17 then sets the ring volume to the maximum in the memory 18 at Step 381. The control circuit 18 can thereby set the ring volume to the maximum in the memory 18 by the remote operation of the service center 100.

As a downlink communication signal from the service center 100 is received through the base station 130 and the public service network 140 by the wireless circuit 12 in the vehicle phone device 10, a receiving voice is outputted from the speaker 60 by the audio processing circuit 11 based on the downlink communication signal. As a transmitting voice is inputted through the microphone 60, an uplink communication signal is transmitted by the wireless circuit 12 to the service center 100 through the base station 130 and the public service network 140 based on the transmitting voice. The above processing is executed in the vehicle phone device 10 and the service center 100 at Steps 350 and 430, respectively.

The crew can thereby have a hands-free call for the emergency call with the operator of the service center 100. When the crew thereafter manipulates for stopping the call through the stop key of the manipulation switch 30, a call stop signal is transmitted from the wireless circuit 12 to the base station 130 and the phone line with the service center 100 is shut off at Step 360. Simultaneously, the phone of the service center 100 terminates the call at Step 440.

When the control circuit 17 of the vehicle phone device 10 receives no ring-off release command through the wireless circuit 12 for the predetermined period (determined at Step 372) after calling to the service center 100 at Step 340, the ring-off release command is determined to be not received at Step 370. The control circuit 17 then, with own determination of the control circuit 17, sets permission of outputting the incoming ring in the memory 18 at Step 371.

Furthermore, when the control circuit 17 of the vehicle phone device 10 receives no ring-volume increase command through the wireless circuit 12 for a predetermined period (determined at Step 382), the ring-volume increase command is determined to be not received at Step 380. The control circuit 17 then, with own determination of the control circuit 17, sets the ring volume to the maximum in the memory 18 at Step 381.

As explained above, the prohibition of outputting the incoming ring is released and the ring volume is set to the maximum, both of which are executed by the remote operation from the phone of the service center 100. Thereby even if the prohibition of outputting the incoming ring is set in the memory 18 during the driving before the emergency state occurs, the incoming ring can be outputted from the ringer 51 at the maximum level of “high” without any manipulation of the crew nor any determination of the vehicle phone device 10. This structure enables the crew to securely receive the incoming call when the emergency state occurs.

Furthermore, When the control circuit 17 of the vehicle phone device 10 receives no ring-off release command or no ring-volume increase command, the control circuit 17 then, with own determination of the control circuit 17, sets permission of outputting the incoming ring in the memory 18 or the ring volume to the maximum in the memory 18. Thereby even if the ring-off release command or the ring-volume increase command cannot be received due to poor communication condition and the like, the crew can securely recognize to receive the incoming call.

(Modification)

The first and second embodiments can be modified below.

Although the setting of the ring volume to the maximum level is executed along with the release of the prohibition of the outputting the incoming ring, only the setting of the ring volume to the maximum level can be executed.

Although the ring volume is set to one of three levels of “low” “intermediate,” and “high”, any number of levels instead of the three levels can be adopted if a plurality of the levels are adopted.

When the emergency state is determined, the ring volume is set to the maximum level. However, the ring volume can be set to a certain level if the certain level of the ring volume can be sufficiently recognizable for the crew.

For instance, the ring volume can be set to four levels such as “extremely low,” “low,” “intermediate,” and “high.” Here, the “intermediate” is assumed to be sufficiently recognizable.

Here, if the ring volume is previously set to any one of “extremely low,” “low,” and “high” before the emergency state occurs, the ring volume can be set to “intermediate” when the emergency state occurs. In addition, if the ring volume is previously set to “intermediate” before the emergency state occurs, the ring volume can continue to be set to “intermediate” when the emergency state occurs.

Furthermore, when the ring volume can be set to four levels such as “extremely low,” “low,” “intermediate,” and “high,” the ring volume can be set to “high” only when the emergency state is determined.

The emergency state is determined based on the spreading signal indicating the spreading of the airbag by the airbag device 20 or the output from the emergency call switch 31. However, the following condition also can be used for the determination of the emergency state. Namely, it is a condition where previously registered phone number of an emergency call is inputted through the manipulation switch 30 (e.g., numeral keys of “0” to “9”) and simultaneously the call start key is manipulated for calling. Furthermore, the emergency state can be determined based on output of an accelerator sensor.

The prohibition of outputting the incoming ring is set through manipulating the ringer prohibition key. However, the control circuit 17 itself can prohibit the outputting of the incoming ring by determining whether output from sensors or the like exceeds a predetermined level. For instance, whether a vehicle is during the driving is determined based on output from a vehicle speed sensor. When the vehicle is determined to be during the driving, the outputting of the incoming ring can be prohibited.

The vehicle phone device 10 is explained as a phone having an emergency call function. However, if a phone has an emergency call function, the invention is directed to any phone such as a wired phone, a cell phone, a personal handy phone (PHS) or the like.

The service center 100 is explained as an emergency call addressee. However, a security service provider, home of a crew, a police, or a fire station can be an emergency call addressee.

In the second embodiment, as soon as it is determined that there is an incoming call from the vehicle phone device 10 at Step 400 in FIG. 7, the phone of the service center 100 transmits a ring-off release command. However, in this situation, an operator of the service center 100 can firstly communicate with the crew if possible. The operator can then determine, based on a result (e.g., no reply, state of the crew) from communication with the vehicle or the crew, whether the ring-off release command should be transmitted.

What is claimed is:

1. A phone provided with an emergency call function that calls to an emergency call addressee when an emergency state occurs, comprising:
emergency determining means for determining whether the emergency state occurs;
emergency calling means for calling to the emergency call addressee that is previously appointed when occurring of the emergency state is determined;
first level setting means for setting, to a certain volume level, a ring volume of an incoming ring that is for notifying a user of an incoming call; and
second level setting means for changing to set the ring volume from the certain volume level to a given volume level that is louder than the certain volume level when occurring of the emergency state is determined.

2. A phone provided with an emergency call function according to claim 1, further comprising:
setting receiving means for receiving, from the emergency call addressee, a ring volume manipulation signal that indicates setting manipulation when occurring of the emergency state is determined,
wherein the second setting means changes to set the ring volume from the certain volume level to the given volume level that is louder than the certain volume level, based on the ring volume manipulation signal.

3. A phone provided with an emergency call function according to claim 2, further comprising:
ring volume reception determining means for determining whether the ring volume manipulation signal is received from the emergency call addressee,
wherein, when occurring of the emergency state is determined and the ring volume manipulation signal is determined to be received, the second setting means changes to set the ring volume from the certain volume level to the given volume level that is louder than the certain volume level.

4. A phone provided with an emergency call function according to claim 1, further comprising:
ring prohibiting means for prohibiting output of the incoming ring; and
ring permitting means for permitting release of prohibiting of the output of the incoming ring when the occurring of the emergency state is determined while the output of the incoming ring is prohibited by the ring prohibiting means.

5. A phone provided with an emergency call function according to claim 4, further comprising:
permission receiving means for receiving, from the emergency call addressee, a ring permission signal that indicates permitting the output of the incoming ring when occurring of the emergency state is determined while the output of the incoming ring is prohibited by the ring prohibiting means,
wherein the ring permitting means permits the release of the prohibiting of the output of the incoming ring based on the ring permission signal.

6. A phone provided with an emergency call function according to claim 5, further comprising:
permission reception determining means for determining whether the ring permission signal is received from the emergency call addressee,
wherein the ring permitting means permits the release of the prohibiting of the output of the incoming ring when the emergency state is determined and the ring permission signal is determined to be received.

7. A phone provided with an emergency call function according to claim 1,
wherein the emergency determining means determines that the emergency state occurs in at least one of two cases,
wherein a first case is that a vehicle in which the phone is provided runs into an accident, and
wherein a second case is that an emergency call switch provided in the vehicle is manipulated.

8. A phone provided with an emergency call function according to claim 7,
wherein the first case is determined by detecting a spreading signal of an airbag that is provided in the vehicle.

9. A ring volume setting change method provided in a phone having an emergency call function that calls to an emergency call addressee when an emergency state occurs, comprising steps of:
setting, to a certain volume level, a ring volume of an incoming ring that is for notifying a user of an incoming call;
determining whether the emergency state occurs;
calling to the emergency call addressee that is previously appointed when occurring of the emergency state is determined; and
changing to setting the ring volume from the certain volume level to a given volume level that is louder than the certain volume level when occurring of the emergency state is determined.

10. A ring volume setting change method according to claim 9, further comprising a step of:
receiving, from the emergency call addressee, a ring volume manipulation signal that indicates the given volume level to be set when occurring of the emergency state is determined.

11. A ring volume setting change method according to claim 9, further comprising steps of:
prohibiting the output of the incoming ring before occurrence of the emergency state is determined; and
permitting release of prohibiting of the output of the incoming ring when occurring of the emergency state is determined while the output of the incoming ring is prohibited at least one of two conditions,
wherein a first condition is that a predetermined period elapses from the occurring of the emergency state is determined and a second condition is that a ring permission signal that indicates permitting the outputting of the incoming ring is received from the emergency call addressee.
